(19) United States
(12) Patent Application Publication
(10) Pub. No.: US 2014/0280568 A1
(43) Pub. Date: Sep. 18, 2014

(54) METHOD AND SYSTEM FOR PROVIDING TRUST ANALYSIS FOR MEMBERS OF A SOCIAL NETWORK

(71) Applicant: SIGNATURE SYSTEMS LLC, Miami Beach, FL (US)

(72) Inventor: Richard Postrel, Miami Beach, FL (US)

(21) Appl. No.: 13/843,744

(22) Filed: Mar. 15, 2013

(51) Int. Cl. H04L 29/08

(52) U.S. Cl. CPC H04L 67/22
USPC 709/204

(57) ABSTRACT

A computer-implemented method of providing a trust analysis comprising forming, using a social network server computer, a social network comprising a plurality of members, each of said members registering with said social network server computer and providing a member profile, each of said member profiles comprising information associated with said member; performing with the social network server computer a member trust factor analysis to generate a member trust factor for each of the plurality of members; performing with the social network server computer a network trust factor analysis of the member trust factors to generate a network trust factor for the social network; and for each of the plurality of members, generating with the social network server computer an adjusted member trust factor by adjusting the member trust factor by the network trust factor.

### TECHNICAL FIELD

This invention relates to trust analysis systems, and in particular to a method and system for generating trust factors based on an aggregate analysis of the members of a social network and providing those trust factors to parties interested in doing business with the members.

### BACKGROUND OF THE INVENTION

There are various mechanisms in the art that attempt to assign some measure of trust/risk to persons, such as credit ratings. Entities known as credit bureaus attempt to assess the creditworthiness of a person by looking at information such as that person's individual or family income level, amount of revolving and installment debt, late payments, number of credit accounts open, etc. These credit ratings are then used by financial and other institutions when lending money or otherwise executing a financial-based transaction such as renting an apartment to that person. In essence, the credit rating provides a limited measure of the trustworthiness of the person with respect to financial dealings.

Credit ratings are limited in several ways. For example, a credit rating takes into account purely financial aspects of that person's trustworthiness. Although financial trustworthiness is important, it is not the only factor that may be analyzed when assessing a trust factor for that person. In addition, the trustworthiness of a person may be judged on more than just an individual basis. A person's trustworthiness is likely affected by the trustworthiness of others with whom that person interacts, which would not be reflected by a simple individual analysis.

Social networking is a paradigm in which groups of members are defined wherein the members interact with each other in desired ways. Typically members of a social network communicate electronically via a social networking service such as FACEBOOK or TWITTER. Members may share images and videos, and may have interactive chat sessions with messaging to select members of their social network. Since members of social networks often have common interests and socioeconomic status, it is desired to be able to utilize the vast amounts of trust and risk assessment information available from those members in order to assess the trustworthiness of an individual who is connected to those members via his or her social networks.

### SUMMARY OF THE INVENTION

In summary, the present invention encompasses a computer-implemented method of providing a trust analysis based on social networks. Using a social network server computer, a social network is formed that includes a plurality of members, each of the members registering with the social network server computer and providing a member profile, each of said member profiles including information associated with the member. The social network server computer performs a member trust factor analysis to generate a member trust factor for each of the plurality of members. The social network server computer also performs a network trust factor analysis of the member trust factors to generate a network trust factor for the social network. Then, for each of the plurality of members, the social network server computer generates an adjusted member trust factor by adjusting the member trust factor by the network trust factor.

The social network server computer may for example use the member profile of the member to generate the member trust factor, and/or it may use information from a public record database to generate the member trust factor. The network trust factor may for example be based on an average of the member trust factors, or it may be based on an aggregate of the member trust factors.

Optionally, entry into the social network may be allowed as a function of the member trust factor of a member, and/or it may be allowed as a function of the adjusted member trust factor of a member.

Further optionally, the member trust factor and/or the adjusted member trust factor may be provided to a third party transactor, wherein the third party transactor uses the member trust factor and/or the adjusted member trust factor for setting transaction parameters in a transaction with the member. The transaction parameters may include an interest rate, a down payment amount, and/or a term amount.

### BRIEF DESCRIPTION OF THE DRAWING

FIG. 1 is a block diagram of a preferred embodiment of the invention.

FIG. 2 is a flowchart of the operation of the preferred embodiment of the invention.

### DESCRIPTION OF THE PREFERRED EMBODIMENTS

The preferred embodiment of the present invention will now be described with respect to the drawing figures. FIG. 1 is a block diagram of the preferred embodiment of the invention. Interrelated social networks 104 are shown with various members A, B, C, D, E, F, G, H, I, J and K. Only eleven members are shown for illustrative purposes, although it is contemplated that the number of members that may be part of the social networks 104 is essentially unlimited. Social networks are constructs as well known the art that provide a communication paradigm amongst its various members. Social networks are groups of persons that interact with each other in some format(s), typically over an electronic communications network such as the Internet. Various social networking services exist, which facilitate interactions amongst the various constituent members that form the social networks. Examples of well-known existing social networking services include FACEBOOK, TWITTER, MYSPACE, AND GOOGLE+. These services enable its members to define various social networks in which the members choose to link with (or friend) each other to share information, images, videos, emails, chat, etc. In this embodiment, the members A, B, C, D, E, F, G, H, I, J and K shown within the dotted oval of FIG. 1 are all registered with the same social network server computer 102 but form different social networks as follows:

social network A: A-B-C-F-K
social network B: B-A-J-E-C
social network C: C-A-B-D-G-E
social network D: D-C
social network E: E-B-C-F
social network F: F-A-E-K-H
social network G: G-C
social network H: H-F-I
social network I: I-J-H
social network J: J-B-I
social network K: K-A-F

That is, member A has linked to members B, C, F and K to form the social network A. Similarly, member B has linked to members A, J, E and C to form the social network B, and so forth. Any information that A chooses to share in his social network A will be received by B, C, F and K. Similarly, any information that B chooses to share in his social network B will be received by A, J, E and C, and so forth. Member A is considered to be the primary member of social network A since he is the common link. Similarly, member B is considered to be the primary member of the social network B since he is the common link. Any member of a social network who is not the primary member of that social network is considered to be a secondary member of that network. Each member of the social networking service will be a primary member to one social network (defined by the secondary members to whom he has linked), and each member is a secondary member to the social networks of those in his social network. Thus, member A is a secondary member to social networks B, C, F and K. Even though E is linked to B, E will not receive information received by B from A since E is not linked to A directly. The term social network 104 is used herein to refer to any of the social networks as described above.

At step 202 in the flowchart of FIG. 3, the social network 104 may be formed amongst its various members utilizing the social network server computer 102 which runs the social networking service. The members of the social network 104 communicate with the social network server computer 102 by using various member computers (not shown), which may be desktop computers, laptop computers, tablets, smartphones, etc. These member computers communicate with the social network server computer 102 through a wired and/or wireless communications network(s) such as the Internet. Typically, each member will register or enroll with the social network server computer 102 and indicate their desire to join a particular social network 104 by linking with at least one of the constituent members of that social network. Any member may invite any other member to join his network, typically by an email message as known in the art. For example, member A has requested members B, C, F and K to link to him, which they have all accepted. Non-members may join the network if desired based on parameters established by the social networking service. As the various members register with the social network server computer 102 and then link with each other, they will be able to interact with each other in various ways, including but not limited to the interactions that will be described herein. Formation of social networks utilizing social network server computers and services is well known in the art.

In addition, members may invite other members of the social networking service, as well as non-members of the service, by issuing a broadcast invitation to groups of member and/or non-members as desired. This may occur over any type of medium, including but not limited to television or radio broadcasts, mass mail and email, etc. Invitees may accept the invitation to join the member's social network and register with the network. As part of the registration process, each member will provide to the social network server computer 102 a member profile that will be stored in the profile database 106 as shown in FIG. 1. The member profile will include various pieces of information that are associated with the member, including but not limited to personal information of the member such as income, age, location, occupation, shopping habits, and/or prior transaction history. Prior transaction history could include purchase transactions and the like. Additionally, the member profile 110 may include a listing of the reward/loyalty/incentive programs with which the member is registered.

With respect to the present invention, each member profile will also include a member trust factor 110. The member's trust factor 110 may be determined by the social network service computer 102 or a third party service in association with the social network service computer 102 if desired. The member trust factor 110 may in a simple embodiment be a number in the scale of 1 through 10, with 1 being the least amount of trustworthiness (and greatest amount of risk) and 10 being the greatest amount of trustworthiness (and least amount of risk). Of course, other indicia and scales may be used as desired. The member trust factor 110 may be stored in the member's profile in the profile database 106 along with other member information as set forth above.

At step 204, the social network server 102 computer performs a member trust factor analysis with member trust factor analysis algorithm 118 to generate a member trust factor for each of the members of the social network. The member trust factor analysis algorithm 118 may for example use profile data from the profile of the member to generate the member trust factor. The member profile data may contain financial information of the member, such as his income, that will enable the calculation of a member trust factor that is relative to that income. For example, a trust factor algorithm may determine that a higher income yields a higher member trust factor, since a member that makes more money could generally be trusted more in a financial transaction, and vice-versa. Or, the member profile may provide the member's age, which may be used to formulate the member trust factor (e.g. an older person may be more trustworthy than a younger person). Similar information may be used from the member profile in a similar manner by the member trust analysis algorithm 118 to provide the member trust factor 110.

In addition to using the member profile data as described above, the member trust factor analysis algorithm 118 may utilize other member-provided ratings of that member 114 to generate the member trust factor. That is, the social network service computer may ask other members of the social network to provide a trust rating for that member. This is subjective information and may be modified by a context factor. For example, a member's brother may be in his social network, and he may be asked to provide a trust rating for that member. That rating may be given extra weight (or less weight) since it has originated from the member's brother rather than from a non-family member. A co-worker's rating of the member may be given normal weight, while an employer's rating of a member may be given even grater weight. These context-specific subjective rating calculations can all contribute to the overall trust factor generated by the member trust factor analysis algorithm 118.

In addition to using the member profile data and other member-provided ratings as described above, the member trust factor analysis algorithm 118 may utilize public data 116 from one or more public record databases 122. For example, a credit bureau may provide data of interest in generating the member trust factor, such as a credit score or the like.

Thus, as described above, the member trust factor may include objective information provided by the member, subjective ratings provided by other members (or non-members), and/or public information provided by external public record databases.

As shown in step 206 of FIG. 2, the social network server computer then performs a network trust factor analysis of all the member trust factors generated in step 204 to generate a network trust factor 112 for the social network. This is performed by the network trust factor analysis algorithm 120 as shown in FIG. 1.

Thus, the social network server computer 102 will generate network A trust factor for social network A, which will be based on the member trust factors for members A, B, C, F and K. Similarly, the social network server computer 102 will generate network B trust factor for social network B, which will be based on the trust factors for members B, A, J, E, and C, and so forth. Thus, each member will have an associated network trust factor 112 that is based on the members in his or her own social network.

Each network trust factor 112 is based on an analysis of the constituent member trust factors 110, and is stored in the profile database 106. The network trust factor is intended to be reflective of the information found in each of the constituent member trust factors, and will subsequently be used in various scenarios as described below. The network trust factor 112 may be generated by the network trust factor analysis algorithm in one or more of various manners.

In one embodiment, the network trust factor 112 may reflect an average trust factor of all of the constituent member trust factors. So, for example, if the member trust factors of the five members of network A are 6, 8, 9, 9, and 7, then the (average) network trust factor for network A is 7.8.

Additionally (or in the alternative), the network profile 112 may reflect an aggregate of all of the constituent member trust factors. So, for example, if the member trust factors of the five members of network A are 6, 8, 9, 9, and 7, then the (aggregate) network trust factor for network A is 39.

Other mechanisms for generating a network trust factor that is in some way representative of some or all of the constituent member trust factors is also contemplated by this invention.

As shown in step 208 of FIG. 2, the social network server computer 102 then generates an adjusted member trust factor by adjusting the member trust factor by the network trust factor. So, in the example above, member A has a member trust factor of 6, but his network trust factor (average) is 7.8, which is a higher value. This signifies that member A is associated through his social network with people who are more trustworthy than his member trust factor would otherwise indicate. As such, his adjusted member trust factor would increase to a value higher than 6. In this example, it will increase to 6.45, since the difference between his member trust factor (6) and his network trust factor (7.8) is 1.8, which when divided by the number of other member in his network (4) yields a difference of 0.45. Thus, member A has benefitted by associating through his social network with other members having a member trust factor than him.

Optionally, entry into the social network may be allowed as a function of the member trust factor of a member, and/or it may be allowed as a function of the adjusted member trust factor of a member. For example, a social network may establish a rule that allows new members only if they have a member trust rating of 8 or above, so as not to devalue their network trust rating. Other social networks may allow lower member trust ratings if desired.

Further optionally at step 210, the member trust factor and/or the adjusted member trust factor may be provided to a third party transactor 108, wherein the third party transactor 108 uses the member trust factor and/or the adjusted member trust factor for setting transaction parameters in a transaction with the member. The transaction parameters may include an interest rate, a down payment amount, and/or a term amount.

Various algorithms may be used in addition to the examples given above in order to generate the member trust factors, the network trust factors, and the adjusted member trust factors. The social network server computer may be programmed to use different algorithms based on the contemplated user of the trust factors (i.e. the third party transactors). That is, a transactor in one market may place a different premium on different factors that provide the trust factor determinations than would a transactor in a different market. As an example, a day care center may wish to obtain trust information about a potential employee. In that case, less emphasis may be placed on that potential employee's financial condition, and perhaps greater emphasis would be placed on the other-member provided trust ratings 114 that may relate to trustworthiness with children. Conversely, a bank that is considering making a loan to someone would want more emphasis placed on financial factors rather than human factors. Thus, by using different algorithms and weighting factors, the goals of the particular third party transactor 108 may be attained.

What is claimed is:

1. A computer-implemented method of providing a trust analysis comprising:
forming, using a social network server computer, a social network comprising a plurality of members, each of said members registering with said social network server computer and providing a member profile, each of said member profiles comprising information associated with said member;
performing with the social network server computer a member trust factor analysis to generate a member trust factor for each of the plurality of members;
performing with the social network server computer a network trust factor analysis of the member trust factors to generate a network trust factor for the social network; and
for each of the plurality of members, generating with the social network server computer an adjusted member trust factor by adjusting the member trust factor by the network trust factor.

2. The method of claim 1 wherein the step of performing with the social network server computer a member trust factor analysis to generate a member trust factor for each of the plurality of members comprises using the member profile of the member to generate the member trust factor.

3. The method of claim 1 wherein the step of performing with the social network server computer a member trust factor analysis to generate a member trust factor for each of the plurality of members comprises using information from a public record database to generate the member trust factor.

4. The method of claim 1 wherein the network trust factor is based on an average of the member trust factors.

5. The method of claim 1 wherein the network trust factor is based on an aggregate of the member trust factors.

6. The method of claim 1 comprising the further step of allowing entry into the social network as a function of the member trust factor of a member.

7. The method of claim 1 comprising the further step of allowing entry into the social network as a function of the adjusted member trust factor of a member.

8. The method of claim 1 further comprising the step of providing the member trust factor to a third party transactor, wherein the third party transactor uses the member trust factor for setting transaction parameters in a transaction with the member.

9. The method of claim 8 wherein the transaction parameters comprise an interest rate, a down payment amount, and a term amount.

10. The method of claim 1 further comprising the step of providing the adjusted member trust factor to a third party transactor, wherein the third party transactor uses the adjusted member trust factor for setting transaction parameters in a transaction with the member.

11. A social network server computer comprising
a profile database comprising a plurality of member profiles, each of the member profiles comprising information associated with a member; and
processing circuitry programmed to:
form a social network comprising a plurality of members;
perform a member trust factor analysis to generate a member trust factor for each of the plurality of members;
perform a network trust factor analysis of the member trust factors to generate a network trust factor for the social network; and
for each of the plurality of members, generate an adjusted member trust factor by adjusting the member trust factor by the network trust factor.

12. The computer of claim 11 programmed to perform a member trust factor analysis to generate a member trust factor for each of the plurality of members by using the member profile of the member to generate the member trust factor.

13. The computer of claim 11 programmed to perform a member trust factor analysis to generate a member trust factor for each of the plurality of members by using information from a public record database to generate the member trust factor.

14. The computer of claim 11 wherein the network trust factor is based on an average of the member trust factors.

15. The computer of claim 11 wherein the network trust factor is based on an aggregate of the member trust factors.

16. The computer of claim 11 further programmed to allow entry into the social network as a function of the member trust factor of a member.

17. The computer of claim 11 further programmed to allow entry into the social network as a function of the adjusted member trust factor of a member.

18. The computer of claim 11 further programmed to provide the member trust factor to a third party transactor, wherein the third party transactor uses the member trust factor for setting transaction parameters in a transaction with the member.

19. The computer of claim 18 wherein the transaction parameters comprise an interest rate, a down payment amount, and a term amount.

20. The computer of claim 11 further programmed to provide the member trust factor to a third party transactor, wherein the third party transactor uses the adjusted member trust factor for setting transaction parameters in a transaction with the member.
